(19) United States
(12) Patent Application Publication
(10) Pub. No.: US 2007/0239860 A1
(43) Pub. Date: Oct. 11, 2007

(54) Information processing device, network connection method, and program recording medium

(75) Inventor: Takuya Shirai, Kawasaki-shi (JP)

Correspondence Address: OSTROLENK FABER GERB & SOFFEN, 1180 AVENUE OF THE AMERICAS, NEW YORK, NY, 100368403, US

(73) Assignee: Kyocera Mita Corporation

(21) Appl. No.: 11/400,680

(22) Filed: Apr. 7, 2006

(51) Int. Cl. G06F 15/177; G06F 15/173

(52) U.S. Cl. 709/221; 709/224

(57) ABSTRACT

An information processing device which is connectable to a network, the information processing device includes: a fixed address setting unit adapted to set a first fixed address of the information processing device in the network; a dynamic address obtaining unit adapted to obtain a dynamic address of the information processing device, using a protocol in the network; an address conflict checking unit which connects the information processing device to the network with the dynamic address obtained by the dynamic address obtaining unit and checks whether or not the first fixed address set by the fixed address setting unit is being used by another device in the network; and a reconnecting unit which disconnects a network connection with the dynamic address and connects the information processing device to the network again with the first fixed address when no conflict of the first fixed address is recognized by the address conflict checking unit.

### BACKGROUND OF THE INVENTION

1. Field of the Invention

The present invention relates to an information processing device connected to a network, a method for connecting devices to a network, and a program recording medium.

2. Description of Related Art

When an information processing device is connected to a network, an address for specifying the information processing device has to be assigned. An Internet Protocol address (an IP address) is assigned when Transmission Control Protocol/Internet Protocol (TCP/IP) is used as a transmission protocol. Since each device connected to the network is identified by its IP address, transmission cannot be carried out properly when one IP address is assigned to a plurality of the information processing devices.

As methods for assigning the aforementioned IP addresses, one for setting a fixed IP address for each information processing device, and one for assigning an IP address available only during connecting to the network, using Dynamic Host Configuration Protocol (DHCP) or the like are known.

In the former method, conflict of IP address is avoided by an IP address administrator providing an IP address for each information processing device. Regarding a printer or the like to be connected to another device, the former method is more preferable than the latter method using DHCP because there is a possibility of the printer becoming unavailable due to changing of the IP address thereof when using DHCP.

As for arts related to this application, arts disclosed in Japanese Unexamined Patent Application, First Publication Nos. 2002-9823 and No. 2003-124935 are known.

However, in the aforementioned method in which the administrator assigns IP addresses, conflict of the IP addresses may occur when one IP address is assigned to a plurality of devices by mistake of the administrator, or when an IP address different from the assigned IP address is set due to an error of the information processing device. Especially, many users of the information processing devices are harmed when the IP address of the printer and the IP address of the other information processing device are in conflict because none of the information processing devices connected to the network can use the printer.

The art disclosed in Japanese Unexamined Patent Application, First Publication No. 2002-9823 teaches a method of obtaining information about IP addresses used in the network, observing broadcast packets such as Address Resolution Protocol (ARP) packets which resolve Media Access Control (MAC) address, from an IP address as a method for solving the aforementioned conflict of IP addresses. However, since this method is to avoid conflict of IP addresses in a dynamic assigning of IP addresses in a network without a DHCP server, this method is not applicable to the aforementioned situation.

The art disclosed in Japanese Unexamined Patent Application, First Publication No. 2003-124935 teaches a method of using an IP address dynamically assigned by DHCP as a fixed address. However, since this method is for dynamic assigning of IP addresses, this is based on a different thought than the invention of this application.

In addition, a method for avoiding conflict of IP addresses using an auto address assigning protocol (AutoIP) is known. However, since this method is also for assigning IP addresses dynamically, this is not applicable for avoiding conflict of fixed IP addresses which a user sets for the information processing devices.

### SUMMARY OF THE INVENTION

In view of the aforementioned circumstances, an object of the present invention is to provide an information processing device, a method for connecting devices to a network, and a program recording medium.

The first aspect of the present invention for accomplishing the aforementioned object is an information processing device which is connectable to a network, the information processing device including: a fixed address setting unit adapted to set a first fixed address of the information processing device in the network; a dynamic address obtaining unit adapted to obtain a dynamic address of the information processing device, using a protocol in the network; an address conflict checking unit which connects the information processing device to the network with the dynamic address obtained by the dynamic address obtaining unit and checks whether or not the first fixed address set by the fixed address setting unit is being used by another device in the network; and a reconnecting unit which disconnects a network connection with the dynamic address and connects the information processing device to the network again with the first fixed address when no conflict of the first fixed address is recognized by the address conflict checking unit.

The information processing device may further include a choice requesting unit adapted to request a user to decide whether to set a second fixed address via the fixed address setting unit again, or to maintain the network connection with the dynamic address when conflict of the first fixed address is recognized by the address conflict checking unit.

The information processing device may further include a second address conflict checking unit which checks whether or not the second fixed address is being used by another device in the network, being connected to the network with the first fixed address when the second fixed address is input via the fixed address setting unit.

The information processing device may further include a notification unit adapted to give notice of cancellation of a change of the first fixed address to a user when conflict of the second fixed address is recognized by the second address conflict checking unit.

The second aspect of the present invention is a recording medium on which a program applicable to an information processing device connectable to a network is recorded, the program including: a first step of setting a first fixed address of the information processing device in the network; a second step of obtaining a dynamic address of the information processing device, using a protocol in the network; a third step of connecting the information processing device to the network with the dynamic address obtained in the second step and checking whether or not the first fixed address is being used by another device in the network; and a fourth step of disconnecting a network connection with the dynamic address and connecting the information processing device to the network again with the first fixed address when no conflict of the first fixed address is recognized in the third step.

The program may further include a fifth step of requesting a user whether to decide to set a second fixed address, or to maintain the network connection with the dynamic address when conflict of the first fixed address is recognized in the third step.

The program may further include a sixth step of checking whether or not the second fixed address is being used by another device in the network while the information processing device is connected to the network with the first fixed address when the second fixed address is input after the fifth step.

The program may further include a seventh step of giving notice of cancellation of a change of the first fixed address to a user when conflict of the second fixed address is recognized in the sixth step.

The third aspect of the present invention is a method for connecting an information processing device to a network, including: a first step of setting a first fixed address of the information processing device in the network; a second step of obtaining a dynamic address of the information processing device, using a protocol in the network; a third step of connecting the information processing device to the network with the dynamic address obtained in the second step and checking whether or not the first fixed address is being used by another device in the network; and a fourth step of disconnecting a network connection with the dynamic address and connecting the information processing device to the network again with the first fixed address when no conflict of the first fixed address is recognized in the third step.

The method for connecting an information processing device to a network may further include a fifth step of requesting a user to decide whether to set a second fixed address, or to maintain the network connection with the dynamic address when conflict of the first fixed address is recognized in the third step.

The method for connecting an information processing device to a network may further include a sixth step of checking whether or not the second fixed address is being used by another device in the network while the information processing device is connected to the network with the first fixed address when the second fixed address is input after the fifth step.

The method for connecting an information processing device to a network may further include a seventh step of giving notice of cancellation of a change of the first fixed address to a user when conflict of the second fixed address is recognized in the sixth step.

### BRIEF DESCRIPTION OF THE DRAWINGS

FIG. 1 is a drawing showing a system constituted by an information processing device according to an embodiment of the present invention and a DHCP server.

FIG. 2 is a flowchart showing an operation flow of the printer of FIG. 1 for connection to the network when starting.

FIG. 3 is a drawing showing a menu display which is displayed while the printer of FIG. 1 is connecting to the network.

FIG. 4 is a flowchart showing an operation flow of the printer of FIG. 1 for changing an IP address.

FIG. 5 is a drawing showing a menu display which is displayed while the printer of FIG. 1 is changing an IP address.

### DETAILED DESCRIPTION OF THE INVENTION

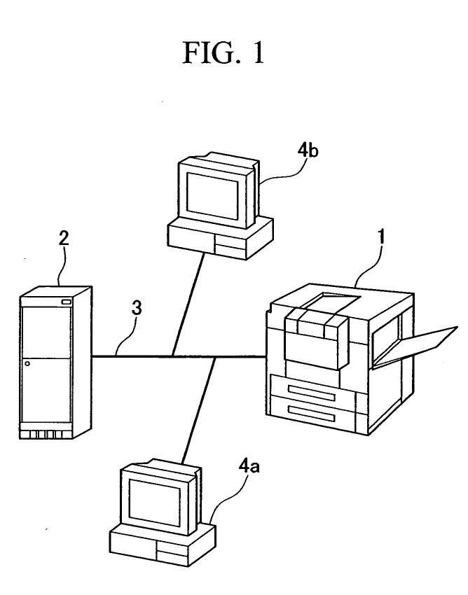

An embodiment of the present invention is described hereinbelow with reference to drawings. FIG. 1 is a drawing of a system constituted by a printer (an information processing device) and a DHCP server. In FIG. 1, the printer 1 and the DHCP server 2 are connected via a network 3. Network devices 4a and 4b are other devices connected to the network 3.

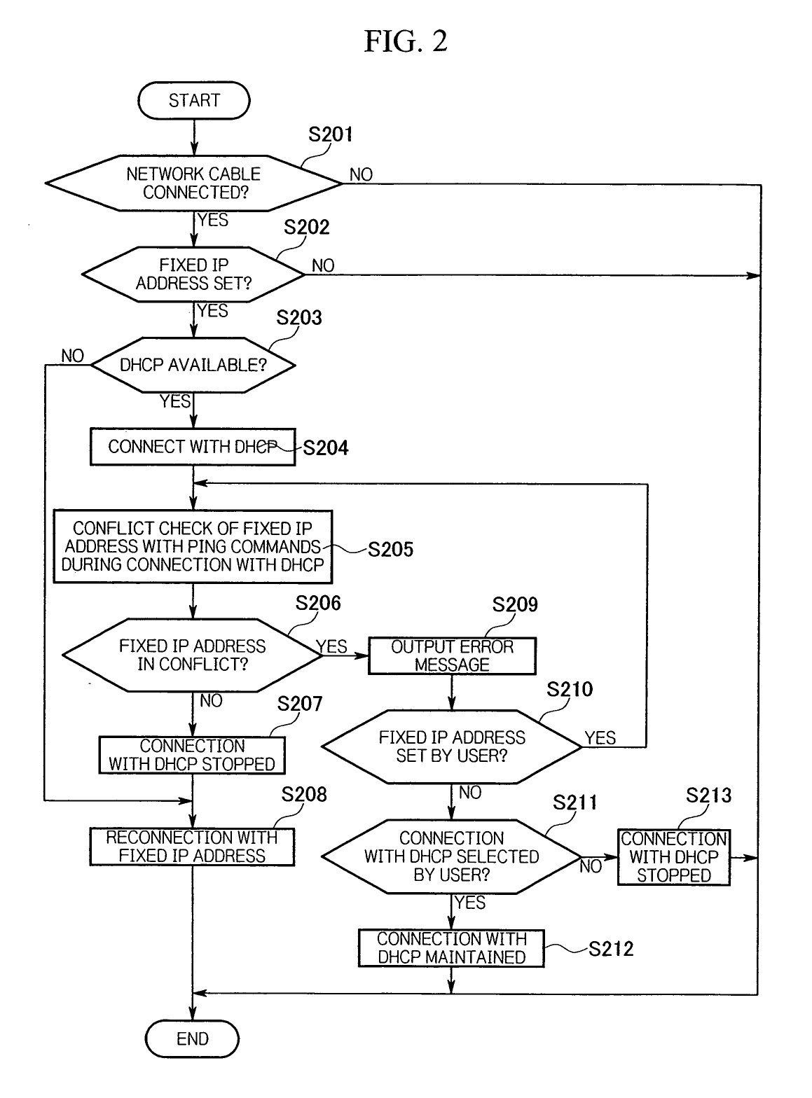

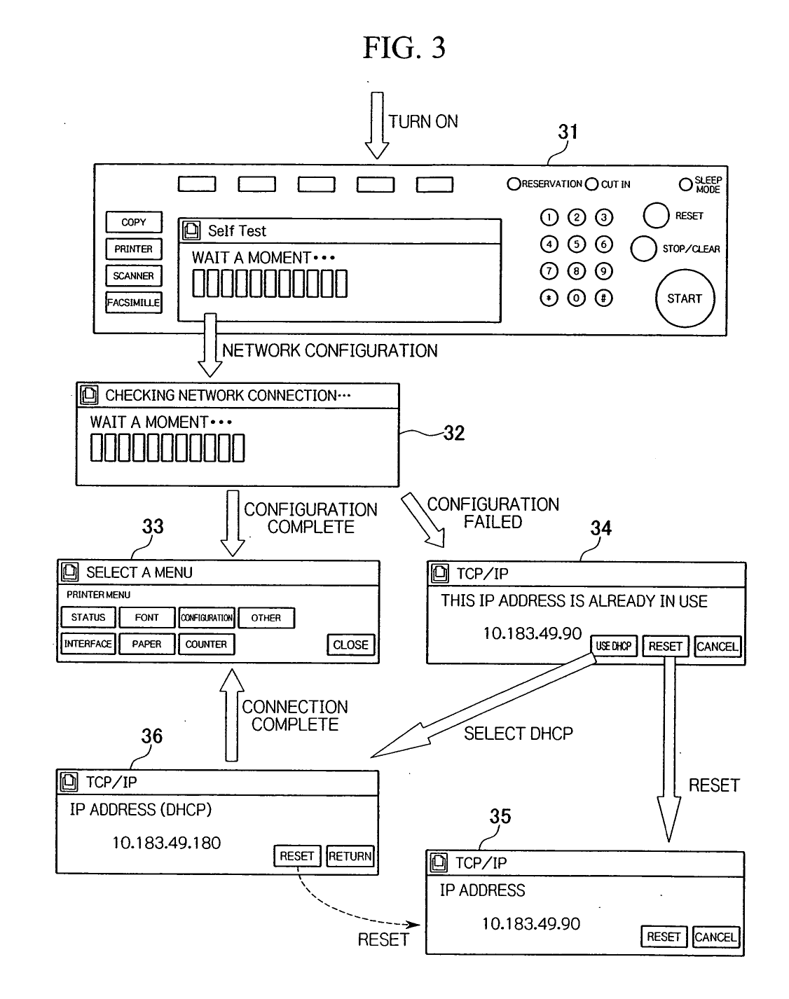

Next, operations of this embodiment are described with reference to FIGS. 2 to 5. FIG. 2 is a flowchart showing operation flow of the printer 1 for connection to the network when starting the printer 1 and FIG. 3 is a drawing which shows a menu display which is displayed while setting an IP address of the printer 1.

When a user turns the printer 1 on, the printer 1 displays a menu display 31 as shown in FIG. 3 and starts establishing a connection with the network. First, the printer 1 detects whether or not a network cable is connected to the printer 1 (step S201 in FIG. 2). The printer 1 displays that a network cable is not connected in the menu display and terminates processing when the network cable is not connected to the printer 1 (NO in step S201).

After checking the connection of the network cable, the printer 1 checks whether or not a fixed IP address (a fixed address) is set for the printer 1 (step S202). The fixed IP address is usually one set during the previous startup process. The printer 1 displays that an IP address will be set in the menu display, and terminates processing when the fixed IP address has not been set yet (NO in step S202).

When the fixed IP address has already been set, the printer 1 displays messages in the menu display as shown in 32 of FIG. 3 and starts connecting to the DHCP server 2 (a dynamic address obtaining unit, step S203 in FIG. 2). When an IP address is not assigned by the DHCP server 2 (NO in step S203), the printer 1 starts connecting to the network 3 with the fixed address (step S208). Then the printer 1 displays that checking of conflict of the IP address was not carried out in the menu display. When an IP address (a dynamic address) is assigned by the DHCP server 2, the printer 1 is connected to the network 3 with the dynamic address (step S204).

After connecting to the network 3 with the dynamic address, the printer 1 checks whether or not the fixed address of the printer 1 is being used by the other devices 4a and 4b in the network, using Packet Internet Groper (PING) commands or Address Resolution Protocol (ARP) commands (an address conflict checking unit, step S205). When there is no response to the PING commands or the ARP commands and it is determined that the fixed IP address is not being used by other devices 4a and 4b in the network 3 (NO in step S206), the printer I disconnects the connection to the network with the dynamic address (step S207) and is connected to the network 3 again with the fixed IP address (step S 208).

After the printer 1 is connected to the network 3 with the fixed IP address, the printer 1 displays messages in the menu display as shown in 33 of FIG. 3 and terminates processing. Since conflict of IP address has already been checked for, a case where the fixed address and IP addresses of the devices 4a and 4b are in conflict can be avoided.

On the other hand, when there is a response to the PING commands or the ARP commands in step S206 in FIG. 2 and it is determined that the fixed IP address is being used by other devices, the printer 1 displays messages in the menu display as shown in 34 of FIG. 3 (step S209 in FIG. 2). Then, if the user chooses to reset the fixed IP address, resetting of the fixed IP address is carried out in the menu display 35 in FIG. 3. After that, the process returns to step S205 and whether or not there is conflict of IP addresses is checked again.

When the user chooses to maintain the connection to the network without resetting the fixed address (YES in step S211), the printer 1 displays the dynamic address assigned by the DHCP server 2 as shown in menu display 36 of FIG. 3 and maintains the connection with the dynamic address (step S212 in FIG. 2). Then the printer 1 displays messages in the menu display as shown in 33 of FIG. 3 and terminates processing. When the user does not choose the connection with the dynamic address, the printer 1 disconnects the connection with the dynamic address and terminates processing (step S213).

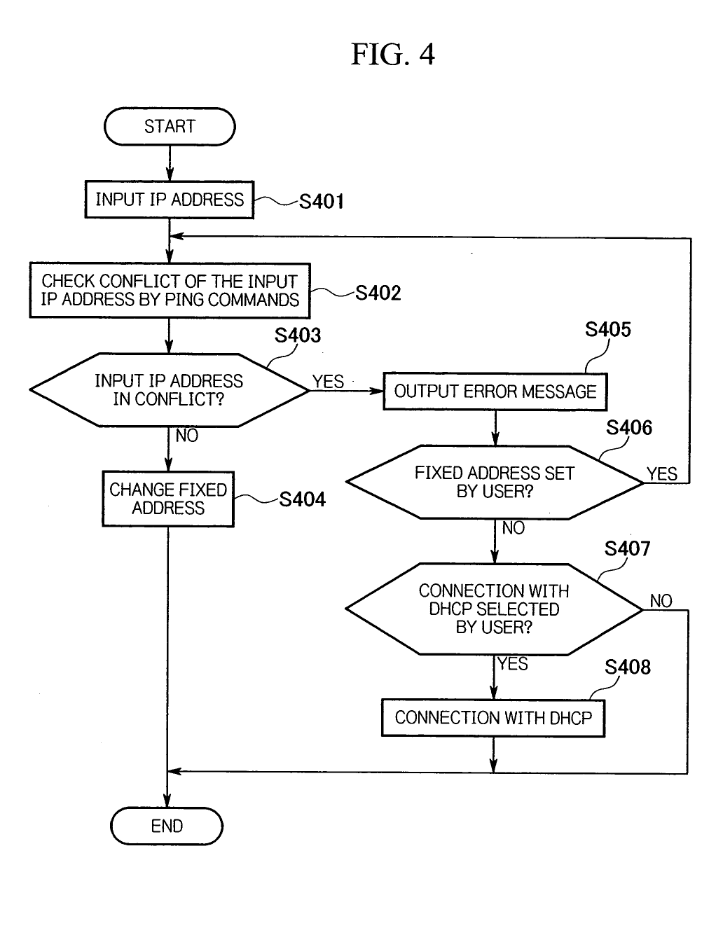

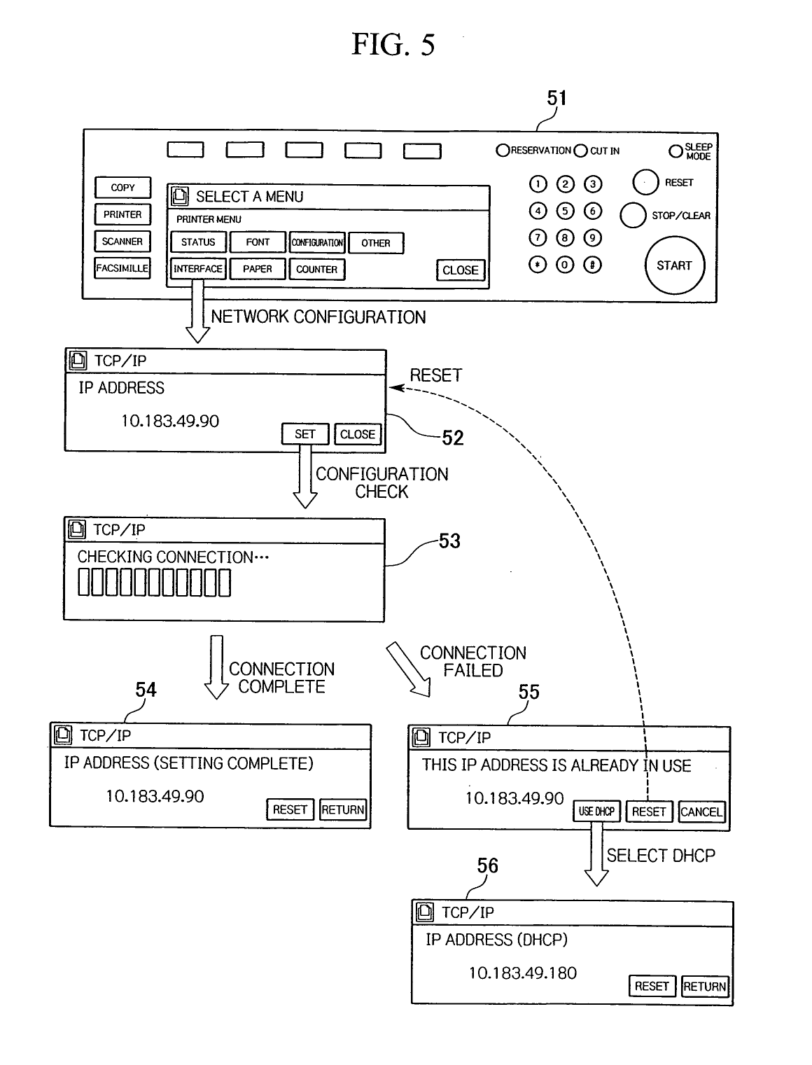

Next, operations for resetting the fixed IP address in the printer 1 are described with reference to FIGS. 4 and 5. FIG. 4 is a flowchart showing an operation flow for changing the fixed IP address of the printer 1 and FIG. 5 shows a menu display which is displayed while the printer 1 is changing the fixed IP address.

When the user selects network configuration mode in the menu display 51 in FIG. 5, the printer 1 displays messages as shown in 52 of FIG. 5. The user inputs an IP address to set to in the menu display (step S401 in FIG. 3). The printer 1 displays messages as shown in 53 of FIG. 5 and checks whether or not the input address of the is being used by the other devices 4a and 4b in the network, using PING commands or ARP commands (a second address conflict checking unit, step S402 in FIG. 4).

When there is no response to PING commands or ARP commands and it is determined that the input IP address is not being used in the network 3 (NO in step S403), the printer 1 displays messages as shown in 54 of FIG. 5, resets the fixed address to the input address (step S404 in FIG. 4) and terminates the processing.

On the other hand, when there is a response to PING commands or ARP commands and it is determined that the input IP address is being used by other devices (YES in step S403), the printer 1 displays error messages in the menu display as shown in 55 of FIG. 5 (step S405 in FIG. 4). Then, when the user chooses to reset the fixed IP address again (YES in step S406), the process returns to step S402 and whether or not there is conflict of IP address is checked again. The printer 1 displays the dynamic address assigned by the DHCP server 2 as shown in menu display 56 of FIG. 5 and terminates the processing. When the user does not choose the connection with the dynamic address, the printer 1 maintains the connection with the fixed address (NO in step S407).

When the user chooses not to reset the fixed IP address but to connect to the network using the DHCP server 2 (YES in step S407), the printer 1 is connected to the DHCP server 2 and is assigned a dynamic address by the DHCP server 2. Then the printer switches the connection to the network to the one with the dynamic address (step S408).

While preferred embodiments of the invention have been described and illustrated above, it should be understood that these are exemplary of the invention and are not to be considered as limiting. Additions, omissions, substitutions, and other modifications can be made without departing from the spirit or scope of the present invention. For example, although the user operates the printer 1 in the menu display thereof, the printer 1 may be operated from other devices in the network 3 as a form of remote control. In addition, the present invention is not only applicable to a printer but also applicable to every kind of device to be connected to a network.

Accordingly, the invention is not to be considered as being limited by the foregoing description, and is only limited by the scope of the appended claims.

What is claimed is:

1. An information processing device which is connectable to a network, the information processing device comprising:
a fixed address setting unit adapted to set a first fixed address of the information processing device in the network;
a dynamic address obtaining unit adapted to obtain a dynamic address of the information processing device, using a protocol in the network;
an address conflict checking unit which connects the information processing device to the network with the dynamic address obtained by the dynamic address obtaining unit and checks whether or not the first fixed address set by the fixed address setting unit is being used by another device in the network; and
a reconnecting unit which disconnects a network connection with the dynamic address and connects the information processing device to the network again with the first fixed address when no conflict of the first fixed address is recognized by the address conflict checking unit.

2. The information processing device according to claim 1, further comprising:
a choice requesting unit adapted to request a user to decide whether to set a second fixed address via the fixed address setting unit again, or to maintain the network connection with the dynamic address when conflict of the first fixed address is recognized by the address conflict checking unit.

3. The information processing device according to claim 1, further comprising:
a second address conflict checking unit which checks whether or not the second fixed address is being used by another device in the network, being connected to the network with the first fixed address when the second fixed address is input via the fixed address setting unit.

4. The information processing device according to claim 3, further comprising:
a notification unit adapted to give notice of cancellation of a change of the first fixed address to a user when conflict of the second fixed address is recognized by the second address conflict checking unit.

5. A recording medium on which a program applicable to an information processing device connectable to a network is recorded, the program comprising:
a first step of setting a first fixed address of the information processing device in the network;
a second step of obtaining a dynamic address of the information processing device, using a protocol in the network;
a third step of connecting the information processing device to the network with the dynamic address obtained in the second step and checking whether or not the first fixed address is being used by another device in the network; and
a fourth step of disconnecting a network connection with the dynamic address and connecting the information processing device to the network again with the first fixed address when no conflict of the first fixed address is recognized in the third step.

6. The recording medium according to claim 5, wherein the program further comprises:
a fifth step of requesting a user to decide whether to set a second fixed address, or to maintain the network connection with the dynamic address when conflict of the first fixed address is recognized in the third step.

7. The recording medium according to claim 5, wherein the program further comprises:
a sixth step of checking whether or not the second fixed address is being used by another device in the network while the information processing device is connected to the network with the first fixed address when the second fixed address is input after the fifth step.

8. The recording medium according to claim 7, the program further comprising:
a seventh step of giving notice of cancellation of a change of the first fixed address to a user when conflict of the second fixed address is recognized in the sixth step.

9. A method for connecting an information processing device to a network, comprising:
a first step of setting a first fixed address of the information processing device in the network;
a second step of obtaining a dynamic address of the information processing device, using a protocol in the network;
a third step of connecting the information processing device to the network with the dynamic address obtained in the second step and checking whether or not the first fixed address is being used by another device in the network; and
a fourth step of disconnecting a network connection with the dynamic address and connecting the information processing device to the network again with the first fixed address when no conflict of the first fixed address is recognized in the third step.

10. The method for connecting an information processing device to a network according to claim 9, further comprising:
a fifth step of requesting a user to decide whether to set a second fixed address, or to maintain the network connection with the dynamic address when conflict of the first fixed address is recognized in the third step.

11. The method for connecting an information processing device to a network according to claim 9, further comprising:
a sixth step of checking whether or not the second fixed address is being used by another device in the network while the information processing device is connected to the network with the first fixed address when the second fixed address is input after the fifth step.

12. The method for connecting an information processing device to a network according to claim 11, further comprising:
a seventh step of giving notice of cancellation of a change of the first fixed address to a user when conflict of the second fixed address is recognized in the sixth step.
